(19) United States
(12) Patent Application Publication
(10) Pub. No.: US 2015/0054861 A1
(43) Pub. Date: Feb. 26, 2015

(54) BRIGHTNESS ADJUSTING CIRCUIT FOR DISPIAY

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: LONG ZHAO, Wuhan (CN)

(21) Appl. No.: 14/465,851

(22) Filed: Aug. 22, 2014

(30) Foreign Application Priority Data
Aug. 22, 2013 (CN) 201310367235X

(51) Int. Cl. G09G 5/10

(52) U.S. Cl. CPC G09G 5/10; G09G 2320/0646; G09G 2320/08
USPC 345/690

(57) ABSTRACT

A brightness adjusting circuit is coupled to a display. The brightness adjusting circuit includes an acquisition module, a conversion module, a control module, and a processing module. The conversion module is connected to the acquisition module. The control module is connected to the conversion module. The processing module is connected to the control module and the conversion module. The display receives brightness signals outputted from the processing module and adjusts the brightness of the display.

### FIELD

The subject matter herein generally relates to a brightness adjusting circuit.

### BACKGROUND

The brightness of display will remain when the brightness of the environment around the display changes, which is uncomfortable for users.

### BRIEF DESCRIPTION OF THE DRAWINGS

Implementations of the present technology will now be described, by way of example only, with reference to the attached figure.

FIG. 1 is a circuit diagram of an acquisition module, a conversion module, a control module, and a processing module of an exemplary embodiment of a brightness adjusting circuit.

FIG. 2 is a circuit diagram of manual controller of the brightness adjusting circuit of FIG. 1.

FIG. 3 is a waveform diagram of analog signals outputted from the acquisition module of the brightness adjusting circuit of FIG. 1.

FIG. 4 is a waveform diagram of digital signals outputted from the conversion module of the brightness adjusting circuit of FIG. 1.

FIG. 5 is a waveform diagram of control signals outputted from the control module of the brightness adjusting circuit of FIG. 1.

FIG. 6 is a waveform diagram of modulation signals regulation by the processing module of the brightness adjusting circuit of FIG. 1.

FIG. 7 is a waveform diagram of brightness signals outputted from the processing module of the brightness adjusting circuit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure is in relation to a brightness adjusting circuit.

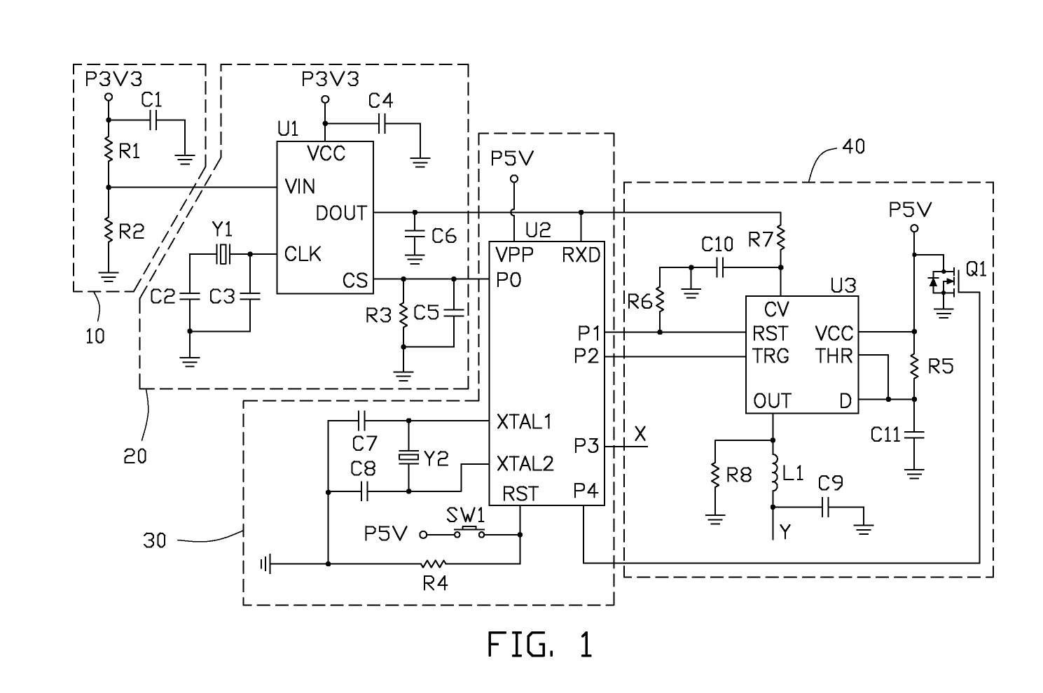

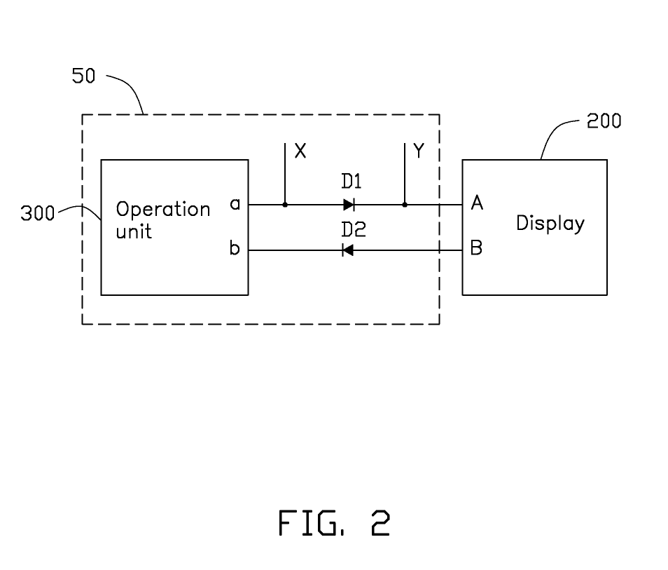

FIG. 1 and FIG. 2 illustrate an embodiment of the brightness adjusting circuit. The brightness adjusting circuit is coupled to a display 200. The brightness adjusting circuit can comprise an acquisition module 10, a conversion module 20, a control module 30, a processing module 40, and a manual controller 50.

The acquisition module 10 can comprise resistors R1, R2 and a capacitor C1. A first terminal of the capacitor C1 is coupled to a power supply P3V3. The first terminal of the capacitor C1 is also coupled to ground through the resistors R1 and R2 in that order. A second terminal of the capacitor C1 is coupled to ground. A node between the resistors R1 and R2 is coupled to the conversion module 20.

The conversion module 20 can comprise an analog-digital converter U1, a crystal oscillator Y1, a resistor R3, and capacitors C2-C6. An input pin VIN of the analog-digital converter U1 is coupled to the node between the resistors R1 and R2. A clock pin CLK of the analog-digital converter U1 is coupled to ground through the crystal oscillator Y1 and the capacitor C2 in that order. The clock pin CLK of the analog-digital converter U1 is also coupled to ground through the capacitor C3. A power pin VCC of the analog-digital converter U1 is coupled to the power supply P3V3. The power pin VCC of the analog-digital converter U1 is also coupled to ground through the capacitor C4. A selection pin CS of the analog-digital converter U1 is coupled to ground through the resistor R3 and the capacitor C5 in parallel. The selection pin CS of the analog-digital converter U1 is also coupled to the control module 30. An output pin DOUT of the analog-digital converter U1 is coupled to ground through the capacitor C6. The output pin DOUT of the analog-digital converter U1 is also coupled to the control module 30 and the processing module 40.

The control module 30 can comprise a single-chip U2, capacitors C7, C8, a resistor R4, a crystal oscillator Y2, and a switch SW1. A power pin VPP of the single-chip U2 is coupled to a power supply PSV. A first pin PO of the single-chip U2 is coupled to the selection pin CS of the analog-digital converter U1. A first clock pin XTAL1 of the single-chip U2 is coupled to a second clock pin XTAL2 of the single-chip U2 through the crystal oscillator Y2. The first clock pin XTAL1 of the single-chip U2 is also coupled to ground through the capacitor C7. The second clock pin XTAL1 of the single-chip U2 is also coupled to ground through the capacitor C8. A reset pin RST of the single-chip U2 is coupled to the power supply P5V through the switch SW1. The reset pin RST of the single-chip U2 is also coupled to ground through the resistor R4. A fourth pin P3 of the single-chip U2 is coupled to the manual controller 50. A second pin P1, a third pin P2, and a fifth pin P4 of the single-chip U2 are coupled to the processing module 40. An input pin RXD of the single-chip U2 is coupled to the output pin DOUT of the analog-digital converter U1.

The processing module 40 can comprise a timer U3, an electronic switch Q1, an inductor L1, four resistors R5-R8, and three capacitors C9-C11. A clock pin TRG of the timer U3 is coupled to the third pin P2 of the single-chip U2. A reset pin RST of the timer U3 is coupled to the second pin P1 of the single-chip U2. The reset pin RST of the timer U3 is also coupled to ground through the resistor R6. A modulation pin CV of the timer U3 is coupled to the output pin DOUT of the analog-digital converter U1 through the resistor R7. The modulation pin CV of the timer U3 is also coupled to ground through the capacitor C10. A power pin VCC of the timer U3 is coupled to the power supply PSV. The power pin VCC of the timer U3 is also coupled to a first terminal of the electronic switch Q1. A second terminal of the electronic switch Q1 is coupled to ground. A control terminal of the electronic switch Q1 is coupled to the fifth pin P4 of the single-chip U2. A lock pin THR of the timer U3 is coupled to the power pin VCC of the timer U3 through the resistor R5. The lock pin THR of the timer U3 is also coupled to ground through the capacitor C11. A discharge pin D of the timer U3 is also coupled to the lock pin THR of the timer U3. An output pin OUT of the timer U3 is coupled to the manual controller 50 through the inductor L1. The output pin OUT of the timer U3 is also coupled to ground through the resistor R8. The output pin OUT of the timer U3 is also coupled to ground through the inductor L1 and the capacitor C9 in that order.

The manual controller 50 can comprise an operation unit 300 and two diodes D1, D2. An output terminal a of the operation unit 300 is coupled to the fourth pin P3 of the single-chip U2. The output terminal a of the operation unit 300 is also coupled to an anode of the diode D1. A cathode terminal of the diode D1 is coupled to an input terminal A of the display 200. An input terminal b of the operation unit 300 is coupled to an anode of the diode D2. A cathode terminal of the diode D2 is coupled to an output terminal B of the display 200. The input terminal A of the display 200 is also coupled to the output pin OUT of the timer U3 through the inductor L1.

In at least one embodiment, the resistor R1 is a photoresistor. A resistance of the resistor R1 changes according to the brightness of environment.

When the selection pin CS of the analog-digital converter U1 receives a high level signal, such as logic 1, the analog-digital converter U1 stops working. The analog-digital converter U1 operates when the selection pin CS of the analog-digital converter U1 does not received any signal. When the reset pin RST of the timer U3 receives a high level signal, the timer U3 is reset. The fifth pin P4 of the single-chip U2 outputs a high level signal when the fourth pin P3 receives any signal.

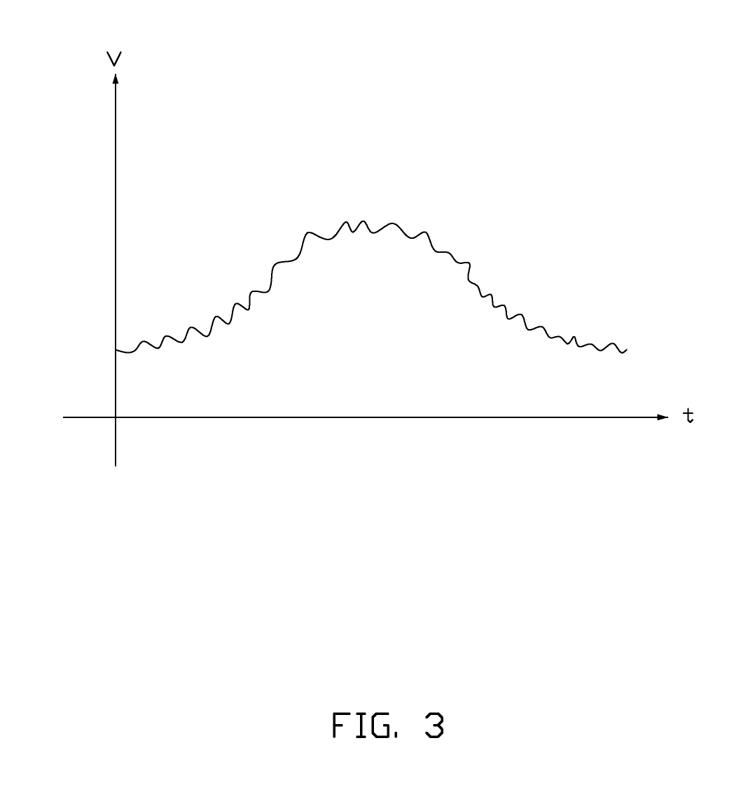

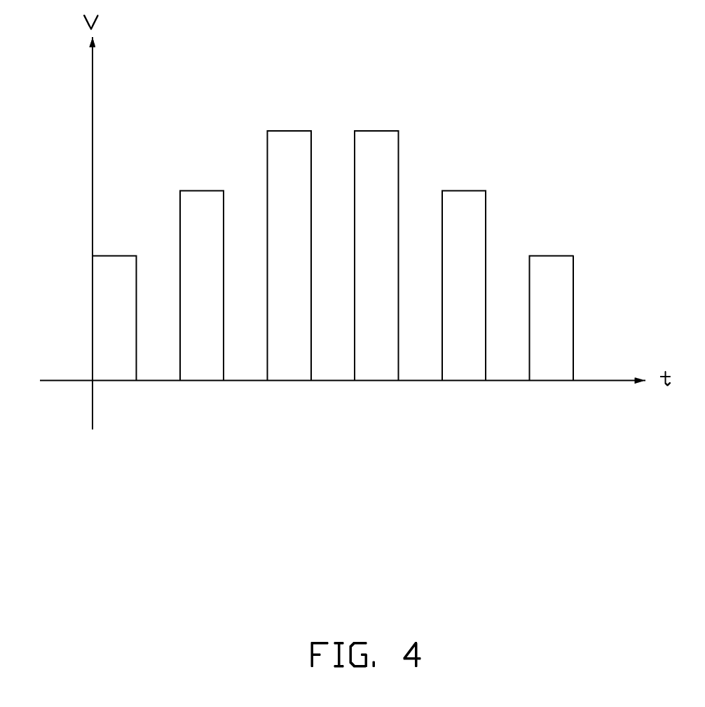

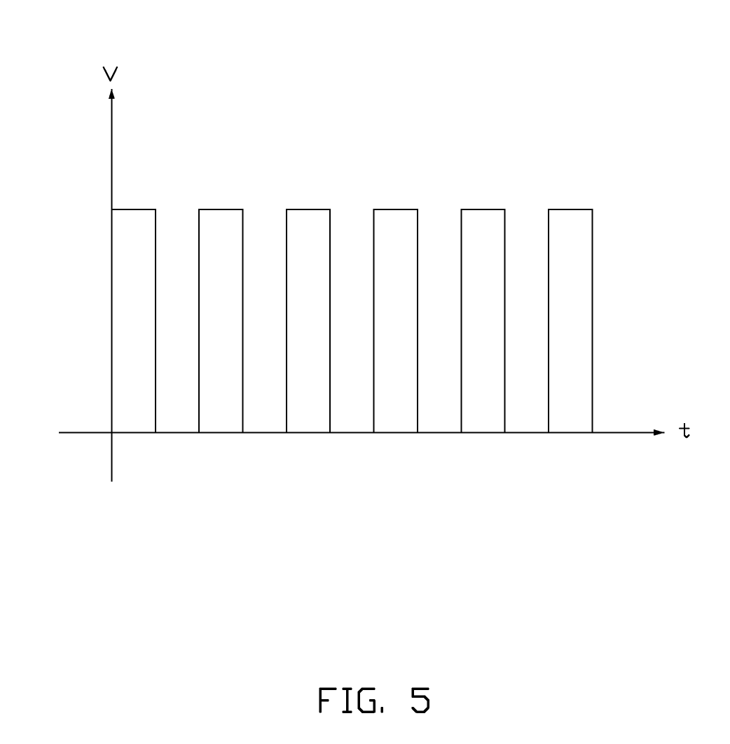

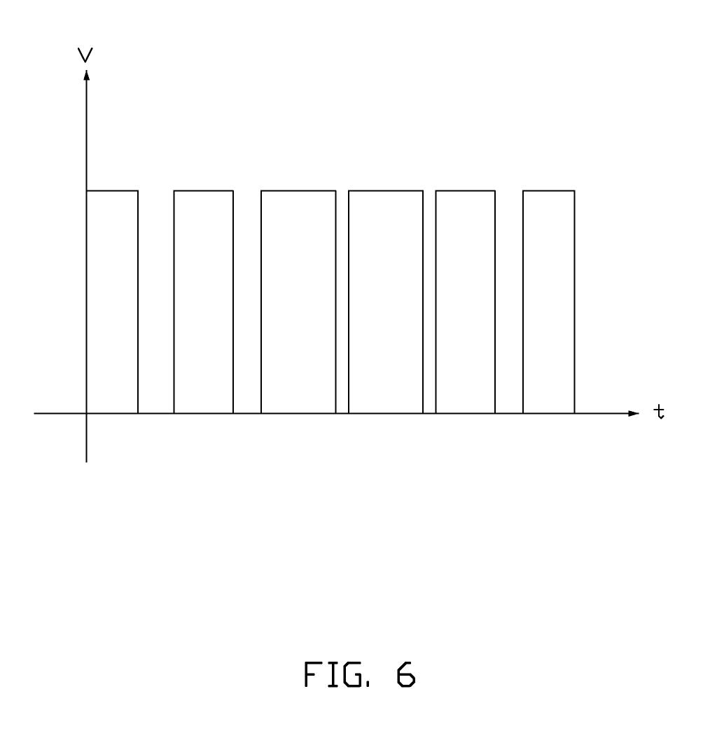

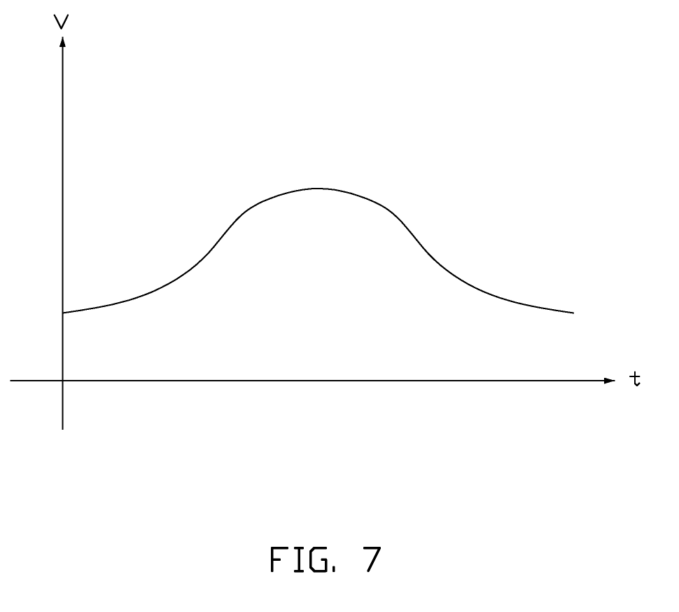

When the brightness adjusting circuit works, the resistance of the resistor R1 changes according to the brightness of environment. Waveform of analog signals received by the input pin VIN of the analog-digital converter U1 is similar to the FIG. 3. The analog-digital converter U1 converts the analog signals received by the input pin VIN to digital signals, and outputs the digital signals through the output pin DOUT of the analog-digital converter U1. Waveform of the digital signals outputted from the output pin DOUT of the analog-digital converter U1 is similar to the FIG. 4. The third pin P2 of the single-chip U2 outputs control signals, similar to the FIG. 5, according to the input pin RXD of the single-chip U2 receives the digital signals. Signal amplitude of the control signals is equal to that of the digital signals, and signal frequency of the control signals is the same as that of the digital signals. The digital signals outputted from the output pin DOUT of the analog-digital converter U1 is received by the modulation pin CV of the timer U3 through the resistor R7 and the capacitor 10. The control signals outputted from third pin P2 of the single-chip U2 is received by the clock pin TRG of the timer U3. At same time, the electronic switch Q1 is turned on because there is no signal outputted from the third pin P4 outputs of the single-chip U2. The power supply P5V supplies power to the timer U3. The output pin OUT of the timer U3 outputs modulation signals, similar to the FIG. 6. The modulation signals turns to brightness signals, similar to the FIG. 7, by the resistor R8, the inductor L1, and the capacitor C1. The display 200 receives the brightness signals and adjusts the brightness of the display 200. The operation unit 300 displays a brightness grade of the display 200 according to brightness signals of the display 200 received by the input terminal b of the operation unit 300.

The input terminal A of the display 200 receives manual signals when someone manual controls the operation unit 300 to adjust the brightness grade of the display 200. The fifth pin P4 of the single-chip U2 outputs a high level signal when the fourth pin P3 of the single-chip U2 receives the manual signals. The electronic switch Q1 is turned off. The power supply P5V stops supplying power to the timer U3 and the timer U3 stops working. The first pin PO of the single-chip U2 outputs a high level signal and the analog-digital converter U1 stops working. The display 200 stops receiving the brightness signals and receives the manual signals to adjust the brightness of the display 200.

When the input terminal A of the display 200 dose not receive the manual signals, connected the power supply P5V and the reset pin RST of the single-chip U2, through the switch SW1, to reset the single-chip U2, and then disconnected the power supply P5V from the reset pin RST of the single-chip U2. The first pin PO of the single-chip U2 stops outputting the high level signal the analog-digital converter U1 turns back to work. The fifth pin P4 of the single-chip U2 stops outputting the high level signal and the power supply P5V turns back to supply power to the timer U3. The second pin P1 of the single-chip U2 outputs a high level signal to the reset pin RST of the timer U3 to reset the timer U3. The display 200 turns back to receive the brightness signals to adjust the brightness of the display 200.

In at least one embodiment, the electronic switch Q1 is an n-channel field effect transistor.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A brightness adjusting circuit coupled to a display, the brightness adjusting circuit comprising:
an acquisition module configured to output an analog signal according to brightness of environment around the display;
a conversion module coupled to the acquisition module and configured to receive the analog signal and convert the analog signal to a digital signal;
a control module coupled to the conversion module and configured to receive the digital signal and then output a control signal; and
a processing module coupled to the conversion module, the control module, and the display, the processing module configured to receive the control signal and the digital signal and then output a brightness signal to the display;
wherein the signal amplitude of the control signals is equal to that of the digital signals, and signal frequency of the control signals is equal to that of the digital signals.

2. The brightness adjusting circuit of claim 1, further comprising a manual controller, wherein the manual controller is coupled to the display and the control module, the manual controller is configured to display a brightness grade of the display according to the brightness signal; wherein when the manual controller outputs a manual signal, the display stops receiving the brightness signal but receives the manual signal to adjust the brightness of the display, and when the manual controller stops output the manual signal, the display turns back to receive the brightness signal to adjust the brightness of the display.

3. The brightness adjusting circuit of claim 2, wherein the acquisition module comprises a first resistor, a second resistor, and a first capacitor, the first resistor is a photoresistor, a first terminal of the first capacitor is coupled to a first power supply, the first terminal of the first capacitor is also coupled to ground through the first and the second resistors in that order, a second terminal of the first capacitor is coupled to ground, and a node between the first and the second resistors is coupled to the conversion module.

4. The brightness adjusting circuit of claim 3, wherein the conversion module comprises an analog-digital converter, a first crystal oscillator, a third resistor, a second capacitor, a third capacitor, a fourth capacitor, a fifth capacitor, and a sixth capacitor, an input pin of the analog-digital converter is coupled to the node between the first and the second resistors, a clock pin of the analog-digital converter is coupled to ground through the first crystal oscillator and the second capacitor in that order, the clock pin of the analog-digital converter is also coupled to ground through the third capacitor, a power pin of the analog-digital converter is coupled to the first power supply, the power pin of the analog-digital converter is also coupled to ground through the fourth capacitor, a selection pin of the analog-digital converter is coupled to ground through the third resistor and the fifth capacitor in parallel, the selection pin of the analog-digital converter is also coupled to the control module, an output pin of the analog-digital converter is coupled to ground through the sixth capacitor, and the output pin of the analog-digital converter is also coupled to the control module and the processing module.

5. The brightness adjusting circuit of claim 4, wherein the control module comprises a single-chip, a seventh capacitor, an eighth capacitor, a fourth resistor, a second crystal oscillator, and a switch, a power pin of the single-chip is coupled to a second power supply, a first pin of the single-chip is coupled to the selection pin of the analog-digital converter, a first clock pin of the single-chip is coupled to a second clock pin of the single-chip through the second crystal oscillator, the first clock pin of the single-chip is also coupled to ground through the seventh capacitor, the second clock pin of the single-chip is also coupled to ground through the eighth capacitor, a reset pin of the single-chip is coupled to the second power supply through the switch, the reset pin of the single-chip is also coupled to ground through the fourth resistor, a second pin, a third pin, and a fourth pin of the single-chip are coupled to the processing module, and an input pin of the single-chip is coupled to the output pin of the analog-digital converter.

6. The brightness adjusting circuit of claim 5, wherein the processing module comprise a timer, an electronic switch, an inductor, a fifth resistor, a sixth resistor, a seventh resistor, an eighth resistor, a ninth capacitor, a tenth capacitor, and an eleventh capacitor, a clock pin of the timer is coupled to the third pin of the single-chip, a reset pin of the timer is coupled to the second pin of the single-chip, the reset pin of the timer is also coupled to ground through the sixth resistor, a modulation pin of the timer is coupled to the output pin of the analog-digital converter through the seventh resistor, the modulation pin of the timer is also coupled to ground through the tenth capacitor, a power pin of the timer is coupled to the second power supply, the power pin of the timer is also coupled to a first terminal of the electronic switch, a second terminal of the electronic switch is coupled to ground, a control terminal of the electronic switch is coupled to the fourth pin of the single-chip, a lock pin of the timer is coupled to the power pin of the timer through the fifth resistor, the lock pin of the timer is also coupled to ground through the eleventh capacitor, a discharge pin of the timer is also coupled to the lock pin of the timer, an output pin of the timer is coupled to an input terminal of the display through the inductor, the output pin of the timer is also coupled to ground through the eighth resistor, and the output pin of the timer is also coupled to ground through the inductor and the ninth capacitor in that order.

7. The brightness adjusting circuit of claim 6, wherein the manual controller comprise an operation unit, a first diode, and a second diode, an output terminal of the operation unit is coupled to the fifth pin of the single-chip, the output terminal of the operation unit is also coupled to an anode of the first diode, a cathode terminal of the first diode is coupled to the input terminal of the display, an input terminal of the operation unit is coupled to an anode of the second diode, a cathode terminal of the second diode is coupled to an output terminal of the display, and the input terminal of the display is also coupled to the output pin of the timer through the inductor.

8. The brightness adjusting circuit of claim 6, wherein the electronic switch is an n-channel field effect transistor.

9. The brightness adjusting circuit of claim 1, wherein the acquisition module comprises a first resistor, a second resistor, and a first capacitor, the first resistor is a photoresistor, a first terminal of the first capacitor is coupled to a first power supply, the first terminal of the first capacitor is also coupled to ground through the first and the second resistors in that order, a second terminal of the first capacitor is coupled to ground, and a node between the first and the second resistors is coupled to the conversion module.

10. The brightness adjusting circuit of claim 9, wherein the conversion module comprises an analog-digital converter, a first crystal oscillator, a third resistor, a second capacitor, a third capacitor, a fourth capacitor, a fifth capacitor, and a sixth capacitor, an input pin of the analog-digital converter is coupled to the node between the first and the second resistors, a clock pin of the analog-digital converter is coupled to ground through the first crystal oscillator and the second capacitor in that order, the clock pin of the analog-digital converter is also coupled to ground through the third capacitor, a power pin of the analog-digital converter is coupled to the first power supply, the power pin of the analog-digital converter is also coupled to ground through the fourth capacitor, a selection pin of the analog-digital converter is coupled to ground through the third resistor and the fifth capacitor in parallel, the selection pin of the analog-digital converter is also coupled to the control module, an output pin of the analog-digital converter is coupled to ground through the sixth capacitor, and the output pin of the analog-digital converter is also coupled to the control module and the processing module.

11. The brightness adjusting circuit of claim 10, wherein the control module comprises a single-chip, a seventh capacitor, an eighth capacitor, a fourth resistor, a second crystal oscillator, and a switch, a power pin of the single-chip is coupled to a second power supply, a first pin of the single-chip is coupled to the selection pin of the analog-digital converter, a first clock pin of the single-chip is coupled to a second clock pin of the single-chip through the second crystal oscillator, the first clock pin of the single-chip is also coupled to ground through the seventh capacitor, the second clock pin of the single-chip is also coupled to ground through the eighth capacitor, a reset pin of the single-chip is coupled to the second power supply through the switch, the reset pin of the single-chip is also coupled to ground through the fourth resistor, a second pin, a third pin, and a fourth pin of the single-chip are coupled to the processing module, and an input pin of the single-chip is coupled to the output pin of the analog-digital converter.

12. The brightness adjusting circuit of claim 11, wherein the processing module comprise a timer, an electronic switch, an inductor, a fifth resistor, a sixth resistor, a seventh resistor, an eighth resistor, a ninth capacitor, a tenth capacitor, and an eleventh capacitor, a clock pin of the timer is coupled to the third pin of the single-chip, a reset pin of the timer is coupled to the second pin of the single-chip, the reset pin of the timer is also coupled to ground through the sixth resistor, a modulation pin of the timer is coupled to the output pin of the analog-digital converter through the seventh resistor, the modulation pin of the timer is also coupled to ground through the tenth capacitor, a power pin of the timer is coupled to the second power supply, the power pin of the timer is also coupled to a first terminal of the electronic switch, a second terminal of the electronic switch is coupled to ground, a control terminal of the electronic switch is coupled to the fourth pin of the single-chip, a lock pin of the timer is coupled to the power pin of the timer through the fifth resistor, the lock pin of the timer is also coupled to ground through the eleventh capacitor, a discharge pin of the timer is also coupled to the lock pin of the timer, an output pin of the timer is coupled to an input terminal of the display through the inductor, the output pin of the timer is also coupled to ground through the eighth resistor, and the output pin of the timer is also coupled to ground through the inductor and the ninth capacitor in that order.

13. The brightness adjusting circuit of claim 12, wherein the electronic switch is an n-channel field effect transistor.
